(19) United States
(12) Patent Application Publication
(10) Pub. No.: US 2023/0144147 A1
(43) Pub. Date: May 11, 2023

(54) PROJECTOR AND PROJECTION METHOD THEREOF

(71) Applicant: Coretronic Corporation, Hsin-Chu (TW)

(72) Inventors: Pen-Ning Kuo, Hsin-Chu (TW); Fu-Shan Wang, Hsin-Chu (TW)

(73) Assignee: Coretronic Corporation, Hsin-Chu (TW)

(21) Appl. No.: 17/981,479

(22) Filed: Nov. 7, 2022

(30) Foreign Application Priority Data
Nov. 8, 2021 (CN) 202111312007.3

(51) Int. Cl. G03B 21/20

(52) U.S. Cl. CPC G03B 21/2013; G03B 21/2066

(57) ABSTRACT

Disclosed is a projector, including a plurality of imaging modules and a control unit. The imaging modules are configured to provide the first light beam, the second light beam, and the third light beam of different wavelengths. The imaging modules include a first imaging module, a second imaging module, and a third imaging module. The control unit respectively provides a first signal, a second signal, and a third signal to the first imaging module, the second imaging module, and the third imaging module. The first imaging module to the third imaging module alternately provide the first light beam to the third light beam respectively according to the first signal to the third signal to form an image light beam. At the same time sequence, the light beams provided by the first imaging module to the third imaging module have different wavelengths.

### CROSS-REFERENCE TO RELATED APPLICATION

This application claims the priority benefit of Chinese application no. 202111312007.3, filed on Nov. 8, 2021. The entirety of the above-mentioned patent application is hereby incorporated by reference herein and made a part of this specification.

### BACKGROUND

### Technical Field

The disclosure relates to an optical device and a method of use thereof, and particularly, to a projector and a projection method thereof.

### Description of Related Art

A projector is a display device for generating a large-size frame, and has been continuously improved with the development and innovation of technology. The imaging principle of the projector is to convert an illumination light beam generated by a lighting system through a light valve into an image light beam, and then project the image light beam through a projection lens onto a projection target (e.g., a screen or a wall) to form a projection frame.

In large-scale exhibitions and performances, to increase projection brightness, multiple projectors are often used to project images toward the same projection target to increase brightness of the image. However, when a projector with three light valves is used to time-sequentially generate monochromatic light (e.g., R, G, and B light) for light mixing, the rainbow effect may be likely to occur, which is relatively apparent during recording, particularly.

The information disclosed in this Background section is only for enhancement of understanding of the background of the described technology and therefore it may contain information that does not form the prior art that is already known to a person of ordinary skill in the art. Further, the information disclosed in the Background section does not mean that one or more problems to be resolved by one or more embodiments of the invention was acknowledged by a person of ordinary skill in the art.

### SUMMARY

The disclosure provides a projector and a projection method thereof, in which the rainbow effect can be alleviated.

Other purposes and advantages of the disclosure may be further understood from the technical features disclosed in the disclosure.

To achieve one, some, or all of the above-mentioned purposes or other purposes, the disclosure provides a projector, including a plurality of imaging modules and a control unit. Each of the imaging modules is configured to provide a first light beam, a second light beam, and a third light beam of different wavelengths. The imaging modules include a first imaging module, a second imaging module, and a third imaging module. The control unit respectively provides a first signal, a second signal, and a third signal to the first imaging module, the second imaging module, and the third imaging module. The first imaging module to the third imaging module alternately provide the first light beam to the third light beam respectively according to the first signal to the third signal to form an image light beam. Moreover, at the same time sequence, the light beams provided by the first imaging module to the third imaging module have different wavelengths.

In an embodiment, the first light beam, the second light beam, and the third light beam are respectively a red light portion of the image light beam, a green light portion of the image light beam, and a blue light portion of the image light beam.

In an embodiment, the imaging modules have the same specification.

In an embodiment, each of the imaging modules includes a single light valve.

In an embodiment, the imaging modules share at least one light combining module.

In an embodiment, projection periods of the imaging modules are sequentially separated by one third of a period.

In an embodiment, the imaging modules are further configured to provide a fourth light beam. The fourth light beam has a wavelength different from the first light beam to the third light beam. The imaging modules further includes a fourth imaging module. The control unit further provides a fourth signal to the fourth imaging module. The first imaging module to the fourth imaging module alternately provide the first light beam to the fourth light beam respectively according to the first signal to the fourth signal to form the image light beam. Moreover, at the same time sequence, the light beams provided by the first imaging module to the fourth imaging module have different wavelengths.

In an embodiment, the first light beam, the second light beam, the third light beam, and the fourth light beam are respectively a red light portion of the image light beam, a green light portion of the image light beam, a blue light portion of the image light beam, and a yellow light portion of the image light beam.

To achieve one, some, or all of the above-mentioned purposes or other purposes, the disclosure also provides a projection method of a projector. The projection method includes the following. A first signal, a second signal, and a third signal are provided to a first imaging module, a second imaging module, and a third imaging module of a plurality of imaging modules. A first light beam, a second light beam, and a third light beam of different wavelengths are alternately provided by the first imaging module to the third imaging module respectively according to the first signal to the third signal to form an image light beam. Moreover, at the same time sequence, the light beams provided by the first imaging module to the third imaging module have different wavelengths.

Based on the foregoing, the embodiments of the disclosure have at least one of the following advantages or effects. In the projector and the projection method thereof of the disclosure, the projector includes the plurality of imaging modules and the control unit. In addition, different parts of the imaging modules alternately provide light beams of different wavelengths according to the different signals provided by the control unit to form the image light beam. As a result, the projector can provide light beams of different wavelengths at each time sequence. Accordingly, in the projection frame projected by the projector, generation of the rainbow effect can be prevented.

Other objectives, features and advantages of the present invention will be further understood from the further technological features disclosed by the embodiments of the present invention wherein there are shown and described preferred embodiments of this invention, simply by way of illustration of modes best suited to carry out the invention.

To make the aforementioned more comprehensible, several embodiments accompanied with drawings are described in detail as follows.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a block diagram of a projector according to an embodiment of the disclosure.

FIG. 2 is a schematic diagram of a light path of the projector in the embodiment of FIG. 1.

FIG. 3 is a schematic diagram of corresponding light beams provided at different time sequences by the projector in the embodiment of FIG. 1.

FIG. 4 is a flowchart of a projection method of a projector according to an embodiment of the disclosure.

FIG. 5 is a schematic diagram of a light path of a projector according to another embodiment of the disclosure.

FIG. 6 is a block diagram of a projector according to another embodiment of the disclosure.

FIG. 7 is a schematic diagram of a light path of the projector in the embodiment of FIG. 6.

FIG. 8 is a schematic diagram of corresponding light beams provided at different timings by the projector in the embodiment of FIG. 6.

FIG. 9 is a flowchart of a projection method of a projector according to another embodiment of the disclosure.

FIG. 10 is a schematic diagram of corresponding light beams provided at different time sequences by a projector according to another embodiment of the disclosure.

### DESCRIPTION OF THE EMBODIMENTS

In the following detailed description of the preferred embodiments, reference is made to the accompanying drawings which form a part hereof, and in which are shown by way of illustration specific embodiments in which the invention may be practiced. In this regard, directional terminology, such as “top,” “bottom,” “front,” “back,” etc., is used with reference to the orientation of the Figure(s) being described. The components of the present invention can be positioned in a number of different orientations. As such, the directional terminology is used for purposes of illustration and is in no way limiting. On the other hand, the drawings are only schematic and the sizes of components may be exaggerated for clarity. It is to be understood that other embodiments may be utilized and structural changes may be made without departing from the scope of the present invention. Also, it is to be understood that the phraseology and terminology used herein are for the purpose of description and should not be regarded as limiting. The use of “including,” “comprising,” or “having” and variations thereof herein is meant to encompass the items listed thereafter and equivalents thereof as well as additional items. Unless limited otherwise, the terms “connected,” “coupled,” and “mounted” and variations thereof herein are used broadly and encompass direct and indirect connections, couplings, and mountings. Similarly, the terms “facing,” “faces” and variations thereof herein are used broadly and encompass direct and indirect facing, and “adjacent to” and variations thereof herein are used broadly and encompass directly and indirectly “adjacent to”. Therefore, the description of “A” component facing “B” component herein may contain the situations that “A” component directly faces “B” component or one or more additional components are between “A” component and “B” component. Also, the description of “A” component “adjacent to” “B” component herein may contain the situations that “A” component is directly “adjacent to” “B” component or one or more additional components are between “A” component and “B” component. Accordingly, the drawings and descriptions will be regarded as illustrative in nature and not as restrictive.

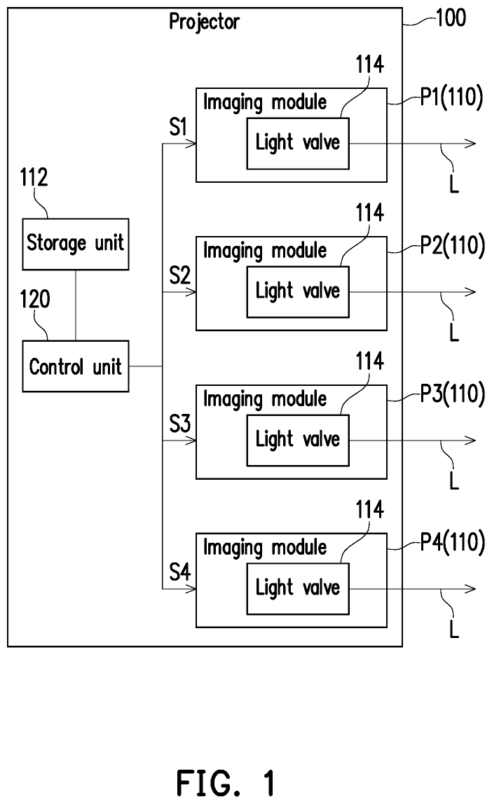

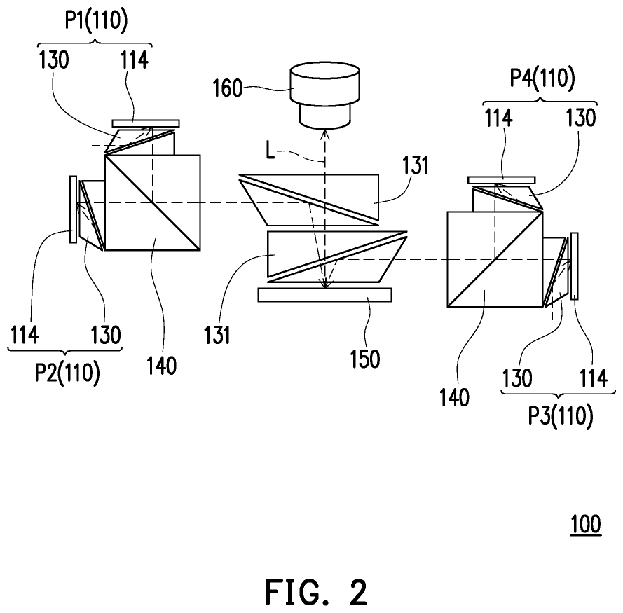

FIG. 1 is a block diagram of a projector according to an embodiment of the disclosure. FIG. 2 is a schematic diagram of a light path of the projector in the embodiment of FIG. 1. With reference to FIG. 1 and FIG. 2, this embodiment provides a projector 100, including a plurality of imaging modules 110, a storage unit 112, and a control unit 120. The control unit 120 is configured to provide control signals (e.g., a first signal S1, a second signal S2, a third signal S3, and a fourth signal S4 shown in FIG. 1) to the imaging modules 110. The imaging modules 110 each provide an image light beam L to the same projection target (not shown), such as a screen or a wall, so that a plurality of image light beams L are overlapped to form an image frame. The projector 100 provided in this embodiment may at least be applied to a projection environment with a plurality of imaging modules 110, such as concerts or outdoor cinemas, among other large-scale exhibitions and performances or occasions for art activity.

The imaging modules 110 each have the same specification. Each of the imaging modules 110 includes a single light valve 114. In other words, the projector 100 in this embodiment uses a plurality of light valves 114, but the disclosure is not limited thereto. The light valve 114 is, for example, a reflective light modulator such as a digital micro-mirror device (DMD) or a reflective liquid crystal on silicon (LCOS). However, the form and the type of the light valve 114 are not limited by the disclosure.

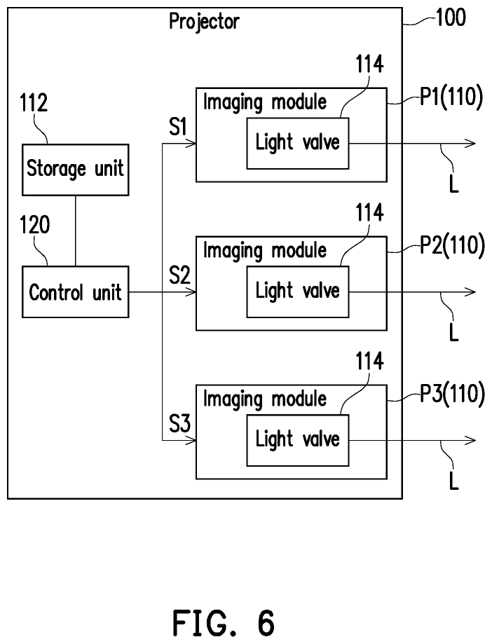

The imaging modules 110 are configured to periodically provide light beams of different wavelengths along with time sequences to form the image light beam L. For example, in this embodiment, the imaging modules 110 provide the first light beam, the second light beam, the third light beam, and the fourth light beam, which are alternately provided along with time sequences. In another embodiment (FIG. 6), the image light beam L comprises at least one of the first light beam, the second light beam and the third light beam. In this embodiment, the image light beam L comprises at least one of the first light beam, the second light beam and the third light beam and the fourth light beam. For example, the first light beam is red light, the second light beam is green light, the third light beam is blue light, and the fourth light beam is yellow light. Therefore, the first light beam, the second light beam, the third light beam, and the fourth light beam are respectively a red light portion of the image light beam L, a green light portion of the image light beam L, a blue light portion of the image light beam L, and a yellow light portion of the image light beam L. In other words, the color of the projector 100 of this embodiment include four colors, i.e., RGBY (red, green, blue and yellow).

In addition, in this embodiment, the storage unit 112 is connected to the control unit 120. The storage unit 112 is configured to store information of a sequence of light beam provision. The storage unit 112 is, for example, a storage device such as memory or a hard disk. For example, in this embodiment, the storage unit 112 stores a first information, a second information, a third information, and a fourth information. The first information is a sequence of light beam provision in which the first light beam, the second light beam, the third light beam, and the fourth light beam are sequentially provided. The second information is a sequence of light beam provision in which the second light beam, the third light beam, the fourth light beam, and the first light beam are sequentially provided. The third information is a sequence of light beam provision in which the third light beam, the fourth light beam, the first light beam, and the second light beam are sequentially provided. The fourth information is a sequence of light beam provision in which the fourth light beam, the first light beam, the second light beam, and the third light beam are sequentially provided. Nonetheless, the disclosure is not limited thereto. In other words, in this embodiment, multiple sequences of light beam provision may be set in advance in the projector 100 to be read and performed by the control unit 120. The imaging modules 110 include a first imaging module P1, a second imaging module P2, a third imaging module P3, and a fourth imaging module P4.

The control unit 120 is, for example, a controller, including a central processing unit (CPU), a microprocessor, a digital signal processor (DSP), a programmable controller, a programmable logic device (PLD), or other similar devices or a combination of these devices, which is not limited by the disclosure. The control unit 120 respectively provides the first signal S1, the second signal S2, the third signal S3, and the fourth signal S4 to the first imaging module P1, the second imaging module P2, the third imaging module P3, and the fourth imaging module P4. The first imaging module P1 to the fourth imaging module P4 respectively provide the first light beam to the fourth light beam according to the first signal S1 to the fourth signal S4 to form the image light beam L. Moreover, at the same time sequence, the light beams (i.e., the first light beam, the second light beam, the third light beam, or the fourth light beam) provided by the first imaging module P1 to the fourth imaging module P4 are different.

In addition, in the embodiment shown in FIG. 2, the projector 100 also includes a plurality of light combining modules 130, 131, a plurality of light splitting elements 140, a reflecting member 150, and a projection lens 160. The light combining modules 130, 131 are, for example, TIR prisms. In this embodiment, the light combining modules 130, 131 may be disposed on a common light path of the image light beams L. And in light paths before guiding lights, the light combining modules 130, 131 are disposed in conjunction with each light valve 114 to form the imaging modules 110. Moreover, on the transmission path of the image light beam L, the light combining module 131 are located between the reflecting member 150 and the projection lens 160. The light splitting element 140 is, for example, a polarization beam splitter (PBS), and is disposed on the path of the image light beam L transmitted by the imaging module 110. On the transmission path of the image light beam L, the light splitting element 140 is disposed between the light valve 114 and the light combining module 131. In other words, in this embodiment, the light splitting element 140 may be utilized for guiding the image light beams L with different polarization properties to save the space of the projector 100. It is worth mentioning that, in this embodiment, the four imaging modules P1 to P4 share two light combining modules 131. After the imaging modules 110 provide the image light beams L to the two shared light combining modules 131, the image light beam L is transmitted to the reflecting member 150 to be transmitted to the projection lens 160 for projection.

In addition, four lighting modules (not shown) corresponding to the four imaging modules P1 to P4 are configured to provide an illumination light beam and transmit the illumination light beam to the four light valves 114 of the four imaging modules P1 to P4 to form the image light beam L.

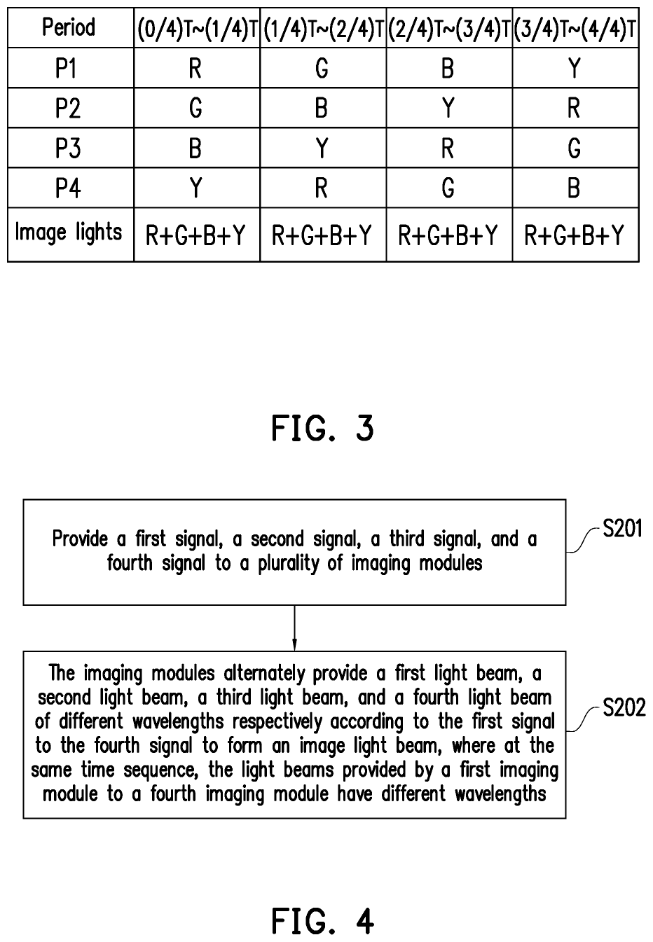

FIG. 3 is a schematic diagram of corresponding light beams provided at different time sequences by the projector in the embodiment of FIG. 1. With reference to FIG. 1 to FIG. 3, in FIG. 3, T represents a period of processing a frame, R represents the red light portion of the image light beam L, G represents the green light portion of the image light beam L, B represents the blue light portion of the image light beam L, and Y represents the yellow light portion of the image light beam L. For example, in this embodiment, the control unit 120 reads the first information stored in the storage unit 112, the first information corresponds to the first signal S1, and the control unit 120 provides the first signal S1 to the first imaging module P1. Therefore, according to the first information, the light valve 114 of the first imaging module P1 provides the first light beam (i.e., the red light portion of the image light beam L) from (0/4)T to (1/4)T, provides the second light beam (i.e., the green light portion of the image light beam L) from (1/4)T to (2/4)T, provides the third light beam (i.e., the blue light portion of the image light beam L) from (2/4)T to (3/4)T, and provides the fourth light beam (i.e., the yellow light portion of the image light beam L) from (3/4)T to (4/4)T. In addition, the control unit 120 reads the second information stored in the storage unit 112, the second information corresponds to the second signal S2, and the control unit 120 provides the second signal S2 to the second imaging module P2. Therefore, according to the second information, the light valve 114 of the second imaging module P2 provides the second light beam from (0/4)T to (1/4)T, provides the third light beam from (1/4)T to (2/4)T, provides the fourth light beam from (2/4)T to (3/4)T, and provides the first light beam from (3/4)T to (4/4)T.

The control unit 120 reads the third information stored in the storage unit 112, the third information corresponds to the third signal S3, and the control unit 120 provides the third signal S3 to the third imaging module P3. Therefore, according to the third information, the light valve 114 of the third imaging module P3 provides the third light beam from (0/4)T to (1/4)T, provides the fourth light beam from (1/4)T to (2/4)T, provides the first light beam from (2/4)T to (3/4)T, and provides the second light beam from (3/4)T to (4/4)T. Furthermore, the control unit 120 reads the fourth information stored in the storage unit 112, the fourth information corresponds to the fourth signal S4, and the control unit 120 provides the fourth signal S4 to the fourth imaging module P4. Therefore, according to the fourth information, the light valve 114 of the fourth imaging module P4 provides the fourth light beam from (0/4)T to (1/4)T, provides the first light beam from (1/4)T to (2/4)T, provides the second light beam from (2/4)T to (3/4)T, and provides the third light beam from (3/4)T to (4/4)T. As a result, the projector 100 can provide the first light beam, the second light beam, the third light beam, and the fourth light beam of different wavelengths at each time sequence. Accordingly, in the projection frame projected by the projector 100, generation of the rainbow effect can be prevented.

FIG. 4 is a flowchart of a projection method of a projector according to an embodiment of the disclosure. With reference to FIG. 1 and FIG. 4, this embodiment provides a projection method of a projector. The method may at least be applied to the projector 100 shown in FIG. 1, so the projector 100 of FIG. 1 is taken as an example for description below. First, step S201 is performed to provide the first signal S1, the second signal S2, the third signal S3, and the fourth signal S4 to the imaging modules 110 including the first imaging module P1, the second imaging module P2, the third imaging module P3, and the fourth imaging module P4. In other words, step S201 is an installation stage of the projector 100. Specifically, the first signal S1, the second signal S2, the third signal S3, and the fourth signal S4 are provided by the control unit 120 of the projector 100. The first imaging module P1, the second imaging module P2, the third imaging module P3, and the fourth imaging module P4 are configured to receive the first signal S1 to the fourth signal S4. To be specific, in this embodiment, there is also included a step of storing the first information, the second information, the third information, and the fourth information into the storage unit 112. In other words, the above step is a design stage of the projector 100. After the above step, step S202 is performed, in which the first imaging module P1 to the fourth imaging module P4 alternately provide the first light beam, the second light beam, the third light beam, and the fourth light beam of different wavelengths respectively according to the first signal S1 to the fourth signal S4 to form the image light beam L. Moreover, at the same time sequence, the light beams provided by the first imaging module P1 to the fourth imaging module P4 have different wavelengths. In other words, step S202 is an operation stage of the projector 100. To be specific, in this embodiment, the control unit 120 first reads the first information, the second information, the third information, and the fourth information stored in the storage unit 112. The first information, the second information, the third information, and the fourth information respectively correspond to the first signal S1, the second signal S2, the third signal S3, and the fourth signal S4. In other words, the control unit 120 reads the first information, the second information, the third information, and the fourth information to form the first signal S1, the second signal S2, the third signal S3, and the fourth signal S4 corresponding to the first information, the second information, the third information, and the fourth information. As a result, through the above steps, the imaging modules 110 can provide the first light beam, the second light beam, the third light beam, and the fourth light beam of different wavelengths at each time sequence. Accordingly, in the projection frame projected by the projector 100, generation of the rainbow effect can be prevented.

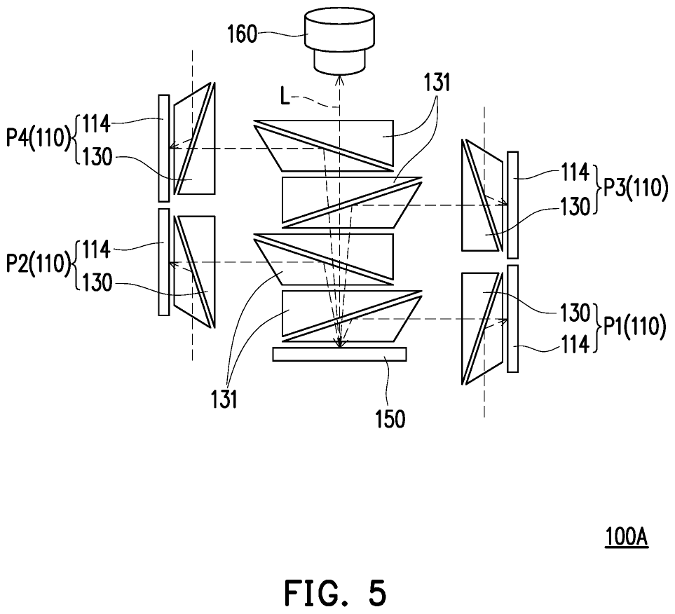

FIG. 5 is a schematic diagram of a light path of a projector according to another embodiment of the disclosure. With reference to FIG. 1 and FIG. 5, a projector 100A shown in this embodiment is similar to the projector 100 shown in FIG. 2. The difference between them lies in that in the projector 100A in this embodiment, the configuration of the light splitting element 140 is omitted, and shared light combining modules 131 are additionally disposed. Therefore, in this embodiment, the image light beams L modulated by the imaging modules 110 can directly enter the light combining modules 131 for guiding light, which simplifies the configuration of light paths and improves the optical quality.

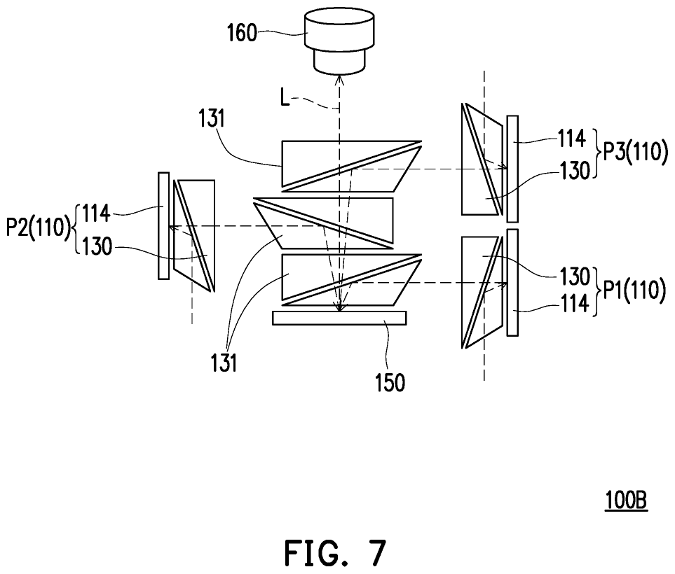

FIG. 6 is a block diagram of a projector according to another embodiment of the disclosure. FIG. 7 is a schematic diagram of a light path of the projector in the embodiment of FIG. 6. With reference to FIG. 6 and FIG. 7, a projector 100B of this embodiment is similar to the projector 100 shown in FIG. 1. The difference between them lies in that the imaging modules 110 in this embodiment provide a first light beam to a third light beam of different wavelengths. For example, in this embodiment, the first light beam to the third light beam are respectively red light, green light, and blue light, for example. In other words, the color of the projector 100B of this embodiment include three colors, i.e., RGB (red, green, and blue).

In addition, in the imaging modules 110 in this embodiment, the fourth imaging module P4 is deleted, and the control unit 120 does not provide the fourth signal S4. Similar to the embodiment of FIG. 1, in this embodiment, the first imaging module P1, the second imaging module P2, and the third imaging module P3 have the same specification.

Moreover, the control unit 120 respectively provides the first signal S1, the second signal S2, and the third signal S3 to the first imaging module P1, the second imaging module P2, and the third imaging module P3. The first imaging module P1 to the third imaging module P3 respectively provide the first light beam to the third light beam according to the first signal S1 to the third signal S3 to form the image light beam L. Moreover, at the same time sequence, the light beams (i.e., the first light beam, the second light beam, or the third light beam) provided by the first imaging module P1 to the third imaging module P3 are different.

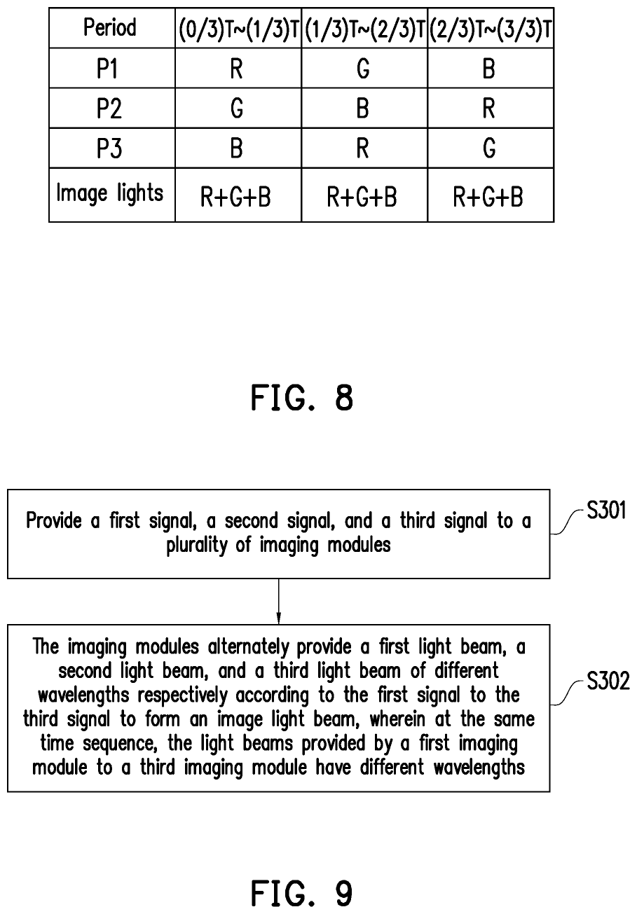

FIG. 8 is a schematic diagram of corresponding light beams provided at different time sequences by the projector in the embodiment of FIG. 6. With reference to FIG. 6 to FIG. 8, in FIG. 8, T represents a period of processing a frame, R represents the red light portion of the image light beam L, G represents the green light portion of the image light beam L, and B represents the blue light portion of the image light beam L. For example, in this embodiment, the control unit 120 reads the first information stored in the storage unit 112, the first information corresponds to the first signal S1, and the control unit 120 provides the first signal S1 to the first imaging module P1. Therefore, according to the first information, the light valve 114 of the first imaging module P1 provides the first light beam (i.e., the red light portion of the image light beam L) from (0/3)T to (1/3)T, provides the second light beam (i.e., the green light portion of the image light beam L) from (1/3)T to (2/3)T, and provides the third light beam (i.e., the blue light portion of the image light beam L) from (2/3)T to (3/3)T. By analogy, the control unit 120 reads the second information and the third information stored in the storage unit 112, the second information and the third information respectively correspond to the second signal S2 and the third signal S3, and the control unit 120 provides the second signal S2 and the third signal S3 to be respectively transmitted to the second imaging module P2 and the third imaging module P3. Therefore, the light valve 114 of the second imaging module P2 provides the second light beam from (0/3)T to (1/3)T, provides the third light beam from (1/3)T to (2/3)T, and provides the first light beam from (2/3)T to (3/3)T. The light valve 114 of the third imaging module P3 provides the third light beam from (0/3)T to (1/3)T, provides the first light beam from (1/3)T to (2/3)T, and provides the second light beam from (2/3)T to (3/3)T. As a result, the projector 100B can provide the first light beam, the second light beam, and the third light beam of different wavelengths at each time sequence. Accordingly, in the projection frame projected by the projector 100B, generation of the rainbow effect can be prevented.

FIG. 9 is a flowchart of a projection method of a projector according to another embodiment of the disclosure. With reference to FIG. 6 and FIG. 9, this embodiment provides a projection method of a projector. The method may at least be applied to the projector 100B shown in FIG. 6, so the projector 100B of FIG. 6 is taken as an example for description below. First, step S301 is performed to provide the first signal S1, the second signal S2, and the third signal S3 to the imaging modules 110 including the first imaging module P1, the second imaging module P2, and the third imaging module P3. In other words, step S301 is an installation stage of the projector 100B. Specifically, the first signal S1, the second signal S2, and the third signal S3 are provided by the control unit 120 of the projector 100B. The first imaging module P1 to the third imaging module P3 are configured to receive the first signal S1 to the third signal S3. To be specific, in this embodiment, there is also included a step of storing the first information, the second information, and the third information into the storage unit 112. In other words, the above step is a design stage of the projector 100B.

After the above step, step S302 is performed, in which the first imaging module P1 to the third imaging module P3 alternately provide the first light beam, the second light beam, and the third light beam of different wavelengths respectively according to the first signal S1 to the third signal S3 to form the image light beam L. Moreover, at the same time sequence, the light beams provided by the first imaging module P1 to the third imaging module P3 have different wavelengths. In other words, step S302 is an operation stage of the projector 100B. To be specific, in this embodiment, the control unit 120 first reads the first information, the second information, and the third information stored in the storage unit 112. The first information, the second information, and the third information respectively correspond to the first signal S1, the second signal S2, and the third signal S3. As a result, through the above steps, the imaging modules 110 can provide the first light beam, the second light beam, and the third light beam of different wavelengths at each time sequence. Accordingly, in the projection frame projected by the projector 100B, generation of the rainbow effect can be prevented.

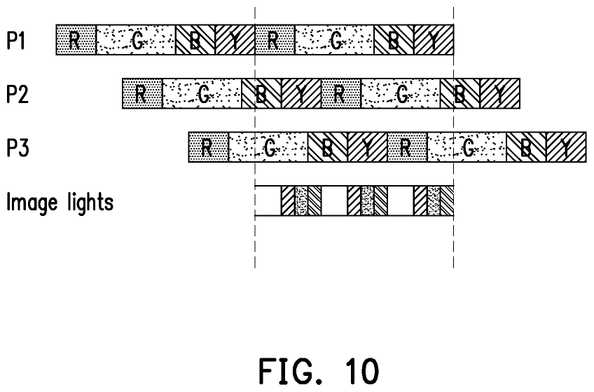

FIG. 10 is a schematic diagram of corresponding light beams provided at different time sequences by a projector according to another embodiment of the disclosure. With reference to FIG. 6, FIG. 7, and FIG. 10, the schematic diagram showing corresponding light beams of this embodiment may at least be applied to the projector 100B shown in FIG. 6 and FIG. 7, so the projector 100B of FIG. 6 and FIG. 7 is taken as an example for description below. In FIG. 10, R represents the red light portion of the image light beam L, G represents the green light portion of the image light beam L, B represents the blue light portion of the image light beam L, and Y represents the yellow light portion of the image light beam L. In this embodiment, projection periods of the image light beams of the imaging modules 110 are separated by one third of a period according to the time sequence. In other words, the first imaging module P1 and the second imaging module P2 are separated by one third of a period, and the second imaging module P2 and the third imaging module P3 are separated by one third of a period. Therefore, after guiding light, the image light beam L can be presented as white light or other color lights, such as yellow, light green, or cyan. Accordingly, not only the projection color formed by the projector 100B with the three imaging modules 110 can achieve the four colors of RGBY (red, green, blue, and yellow), but in the projection frame projected by the projector 100B, generation of the rainbow effect can also be prevented.

In summary of the foregoing, in the projector and the projection method thereof of the disclosure, the projector includes the plurality of imaging modules and the control unit. The imaging modules alternately provide light beams of different wavelengths according to the different signals provided by the control unit to form the image light beam. As a result, the projector can provide light beams of different wavelengths at each time sequence. Accordingly, in the projection frame projected by the projector, generation of the rainbow effect can be prevented.

The foregoing description of the preferred embodiments of the invention has been presented for purposes of illustration and description. It is not intended to be exhaustive or to limit the invention to the precise form or to exemplary embodiments disclosed. Accordingly, the foregoing description should be regarded as illustrative rather than restrictive. Obviously, many modifications and variations will be apparent to practitioners skilled in this art. The embodiments are chosen and described in order to best explain the principles of the invention and its best mode practical application, thereby to enable persons skilled in the art to understand the invention for various embodiments and with various modifications as are suited to the particular use or implementation contemplated. It is intended that the scope of the invention be defined by the claims appended hereto and their equivalents in which all terms are meant in their broadest reasonable sense unless otherwise indicated. Therefore, the term “the invention”, “the present invention” or the like does not necessarily limit the claim scope to a specific embodiment, and the reference to particularly preferred exemplary embodiments of the invention does not imply a limitation on the invention, and no such limitation is to be inferred. The invention is limited only by the spirit and scope of the appended claims. Moreover, these claims may refer to use “first”, “second”, etc. following with noun or element. Such terms should be understood as a nomenclature and should not be construed as giving the limitation on the number of the elements modified by such nomenclature unless specific number has been given. The abstract of the disclosure is provided to comply with the rules requiring an abstract, which allow a searcher to quickly ascertain the subject matter of the technical disclosure of any patent issued from this disclosure. It is submitted with the understanding that it will not be used to interpret or limit the scope or meaning of the claims. Any advantages and benefits described may not apply to all embodiments of the invention. It should be appreciated that variations may be made in the embodiments described by persons skilled in the art without departing from the scope of the present invention as defined by the following claims. Moreover, no element and component in the present disclosure is intended to be dedicated to the public regardless of whether the element or component is explicitly recited in the following claims.

What is claimed is:

1. A projector, comprising:
a plurality of imaging modules, wherein each of the imaging modules is configured to provide a first light beam, a second light beam, and a third light beam of different wavelengths, and the imaging modules comprise a first imaging module, a second imaging module, and a third imaging module; and
a control unit, respectively providing a first signal, a second signal, and a third signal to the first imaging module, the second imaging module, and the third imaging module, wherein the first imaging module to the third imaging module alternately provide the first light beam to the third light beam respectively according to the first signal to the third signal to form an image light beam, and at the same time sequence, the light beams provided by the first imaging module to the third imaging module have different wavelengths.

2. The projector according to claim 1, wherein the first light beam, the second light beam, and the third light beam are respectively a red light portion of the image light beam, a green light portion of the image light beam, and a blue light portion of the image light beam.

3. The projector according to claim 1, wherein the imaging modules have the same specification.

4. The projector according to claim 1, wherein each of the imaging modules comprises a single light valve.

5. The projector according to claim 1, wherein the imaging modules share at least one light combining module.

6. The projector according to claim 1, wherein projection periods of the imaging modules are sequentially separated by one third of a period.

7. The projector according to claim 1, wherein the imaging modules are further configured to provide a fourth light beam having a wavelength different from the first light beam to the third light beam, the imaging modules further comprises a fourth imaging module, and the control unit further provides a fourth signal to the fourth imaging module, wherein the first imaging module to the fourth imaging module alternately provide the first light beam to the fourth light beam respectively according to the first signal to the fourth signal to form the image light beam, and at the same time sequence, the light beams provided by the first imaging module to the fourth imaging module have different wavelengths.

8. The projector according to claim 7, wherein the first light beam, the second light beam, the third light beam, and the fourth light beam are respectively a red light portion of the image light beam, a green light portion of the image light beam, a blue light portion of the image light beam, and a yellow light portion of the image light beam.

9. A projection method of a projector, comprising:
providing a first signal, a second signal, and a third signal to a first imaging module, a second imaging module, and a third imaging module of a plurality of imaging modules; and
by the first imaging module to the third imaging module, alternately providing a first light beam, a second light beam, and a third light beam of different wavelengths respectively according to the first signal to the third signal to form an image light beam, wherein at the same time sequence, the light beams provided by the first imaging module to the third imaging module have different wavelengths.

10. The projection method according to claim 9, wherein the imaging modules share at least one light combining module.

11. The projection method according to claim 9, wherein projection periods of the imaging modules are sequentially separated by one third of a period.

12. The projection method according to claim 9, further comprising:
storing a first information, a second information, and a third information into the projector; and
respectively reading the first information, the second information, and the third information to form the first signal, the second signal, and the third signal corresponding to the first information, the second information, and the third information.

13. The projection method according to claim 9, further comprising:
providing a fourth signal to a fourth imaging module of the imaging modules; and
by the first imaging module to the fourth imaging module, alternately providing the first light beam, the second light beam, the third light beam, and a fourth light beam of different wavelengths respectively according to the first signal to the fourth signal to form the image light beam, wherein at the same time sequence, the light beams provided by the first imaging module to the fourth imaging module have different wavelengths.
